(19) United States
(12) Patent Application Publication
(10) Pub. No.: US 2025/0135810 A1
(43) Pub. Date: May 1, 2025

(54) TONGUE WEIGHT SCALE

(71) Applicant: B & W Custom Truck Beds, Inc., Humboldt, KS (US)

(72) Inventors: Travis M. McCall, Humboldt, KS (US); Tyler Jelinek, Manhattan, KS (US); Thomas Corie, Provo, UT (US)

(73) Assignee: B & W Custom Truck Beds, Inc., Humboldt, KS (US)

(21) Appl. No.: 18/932,011

(22) Filed: Oct. 30, 2024

Related U.S. Application Data
(60) Provisional application No. 63/594,185, filed on Oct. 30, 2023.

(51) Int. Cl. B60D 1/24; B60D 1/46

(52) U.S. Cl. CPC B60D 1/248; B60D 1/46

(57) ABSTRACT

A tongue weight scale includes a coupling head configured to support a coupler of a trailer thereon to measure a weight that corresponds to a force exerted by the coupler. A height adjustable assembly includes an inner sleeve telescopingly mounted within an outer sleeve and means for securing a longitudinal position of the inner sleeve relative to an outer sleeve to adjust a height of the coupling head to a weight measurement height. A load cell is supported within a load cell housing, and a mount is secured within the load cell housing to rigidly support the load cell in a position to detect the force exerted on the coupling head by the coupler and provide an output signal corresponding to the force. A display assembly is communicatively connected to the load cell and configured to receive the output signal.

### CROSS-REFERENCE TO RELATED APPLICATIONS

This application claims the benefit of U.S. Provisional Patent Application No. 63/594,185, filed Oct. 30, 2023, the disclosure of which is hereby incorporated herein in its entirety by reference.

### BACKGROUND OF THE INVENTION

### Field of the Invention

This invention relates to a weight measuring device, and, more specifically, to a coupling head mounting structure for measuring a tongue weight of a trailer.

### Background

Tongue weight or hitch weight is the downward force exerted by a coupler of a trailer on a hitch ball secured to a tow vehicle. Typically, a safe tongue weight is between 10 and 15 percent of a gross weight of the trailer. Too little tongue weight applied to the hitch ball can result in swaying of the trailer relative to the tow vehicle. Too much tongue weight applied to the hitch ball can result in overloading of the tow vehicle making it difficult for a driver to control the trailer while driving and decreasing responsiveness of the tow vehicle during steering and braking. Traffic accidents, damage to the tow vehicle and trailer, and potential injury, or even death, may result from having an improper tongue weight exerted on the tow vehicle by the trailer.

Tongue weight on the tow vehicle can be altered by adjusting a position of cargo in the trailer or removing cargo from the trailer. For example, moving cargo closer to a forward end of the trailer will increase tongue weight and moving cargo further from the forward end of the trailer will decrease tongue weight. A tongue weight scale provides a real time measurement of the tongue weight of the trailer for appropriate positioning of cargo in the trailer.

### SUMMARY OF THE INVENTION

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a weighing device that includes coupling head configured to support a coupler of a trailer thereon. A foot is configured to support the weighing device on a surface. A height adjustable assembly includes a first sleeve that is telescopingly mounted within and moves relative to a second sleeve and a means for selectively securing a longitudinal position of the first sleeve relative to the second sleeve to adjust a height of the coupling head relative to the foot. The height adjustable assembly is securable in a selected position that corresponds to a weight measurement height of the coupling head.

A weight measuring assembly detects and transmits an output signal that corresponds to a force exerted on the coupling head, and includes a weight measurement device and a mount spaced above the foot positioned to rigidly support the weight measurement device in a position to be engaged when a force is exerted on the coupling head. The weight measurement device includes a load cell. A load cell housing is configured to support the weight measuring assembly, and the load cell is mounted and supported within the load cell housing. The load cell is secured above the mount within the load cell housing. In an embodiment, the load cell housing is coupled and secured to the first sleeve of the height adjustable assembly at an upper end thereof.

The coupling head includes a post extending therefrom, and the post of the coupling head extends within the load cell housing and is movably supported by the sidewalls of the load cell housing. The coupling head is moveable such that the post engages the load cell when a force is exerted on the coupling head. A force applied to the coupling head causes the coupling head to move within a range of motion limited by at least one aperture to engage the load cell. The load cell includes one or more sensing elements that are configured to detect a force applied to the coupling head and transmit an output signal that corresponds to the force. A display assembly is configured to receive the output signal and display a numeric value corresponding to the output signal.

### BRIEF DESCRIPTION OF THE DRAWINGS

Embodiments of the invention are described in detail below with reference to the attached drawing figures, wherein:

FIG. 1 is a perspective view of a tongue weight scale, including a coupling head, a height adjustable assembly, and a display assembly;

FIG. 2 is a cross sectional view of the tongue weight scale along line 2-2 of FIG. 1, including a weight measuring assembly;

FIG. 3 is a cross sectional view of the tongue weight scale of FIG. 1, along line 3-3 of FIG. 2;

FIG. 4 is an enlarged, fragmentary view of the weight measuring assembly in FIG. 2;

FIG. 5 is a cross-sectional view of an alternate embodiment of a tongue weight scale that includes an S-shaped load cell;

FIG. 6 is a perspective view of the alternate embodiment of the tongue weight scale in FIG. 5;

FIG. 7 is a perspective view of a second alternative embodiment of a tongue weight scale;

FIG. 8 is a cross-section view of the second alternative embodiment along line 8-8 of FIG. 7, including a display assembly; and

FIG. 9 is a cross-sectional view of the second alternative embodiment along line 9-9 of FIG. 7.

The drawing figures do not limit the invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

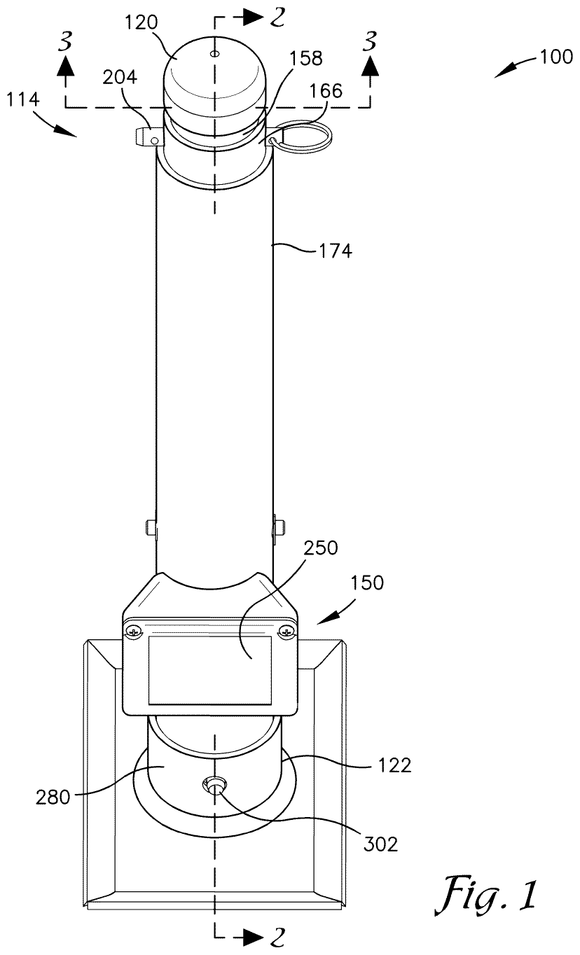

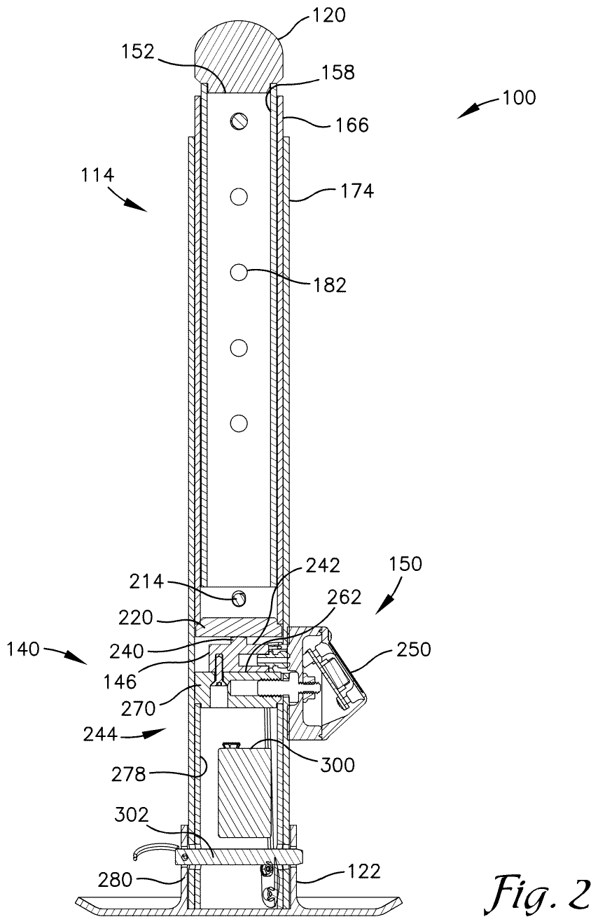

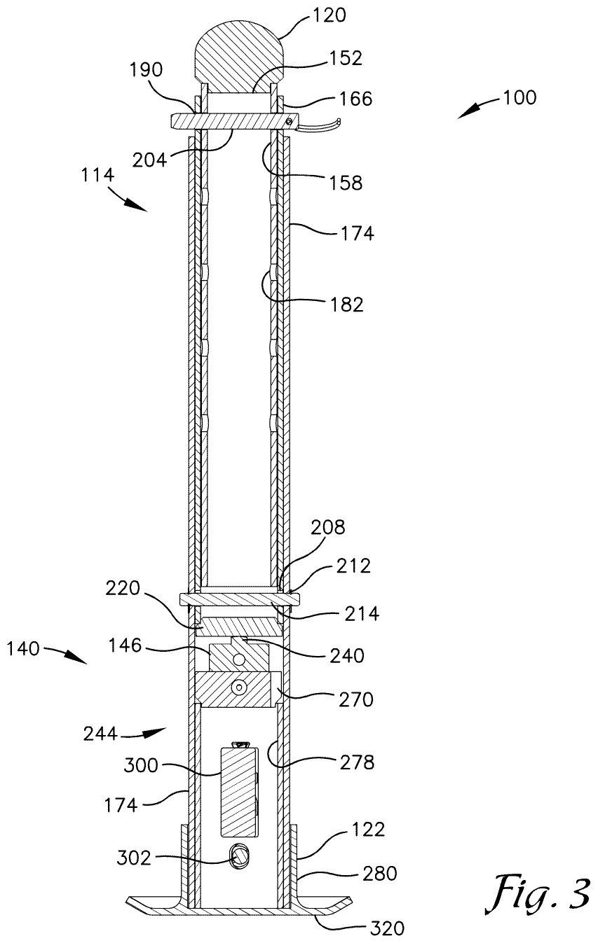

In an embodiment of the invention disclosed herein, a tongue weight scale or weighing device 100 is configured to display or communicate a measurement of weight or load that corresponds to a downward force exerted by a coupler or tongue of a trailer or vehicle on a hitch ball secured to a tow vehicle. FIG. 1 shows a perspective view of the tongue weight scale 100 that includes a height adjustable assembly 114 coupled to and supporting a coupling head or ball mount 120 configured for supporting the coupler of the trailer, and a foot, base or support 122 for supporting the tongue weight scale 100 on a surface. The height adjustable assembly 114 may also be referred to as a height adjustable housing or a height adjustable ball mount support. FIGS. 2 and 3 show cross sectional views of the tongue weight scale 100 that include a weight measuring assembly 140 having a weight measurement device 146, such as, for example, a load cell, incorporated into the tongue weight scale 100. A force of a trailer coupler acting on the coupling head 120 results in engagement of the load cell 146 of the weight measuring assembly 140. In an embodiment, the height adjustable assembly 114 transfers an applied force exerted on the coupling head 120 to the weight measuring assembly 140. The weight measuring assembly 140 includes a display assembly 150 that receives a signal from the load cell 146 to display the tongue weight associated with the coupler of the trailer acting on the tongue weight scale 100.

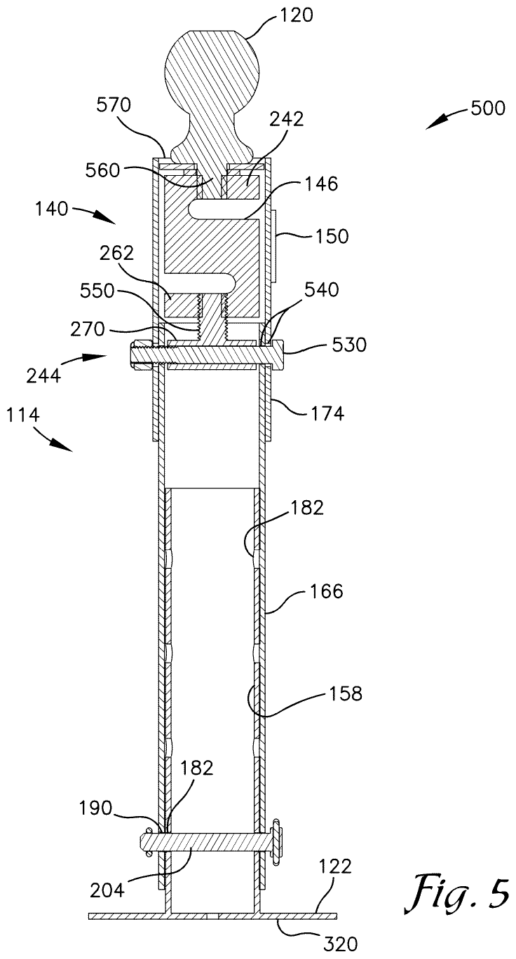

In the embodiment shown, the tongue weight scale 100 includes the load cell 146 having one or more strain gauges that measures a compressive force of the tongue or coupler of a trailer on the coupling head 120. The load cell 146 detects an applied force through changes in electrical resistance. Although a button load cell is shown in FIGS. 1-4, it is understood by one skilled in the art that other types of load cells configured for compressive loads can be utilized in the tongue weight scale 100, such as, for example, a pancake or a disk load cell, a canister load cell, or an S-shaped load cell, such as the S-shaped load cell shown in FIG. 5.

The coupling head 120 is ball- or dome-shaped and sized to support a tongue or coupler of the trailer thereon. The coupling head 120 may be formed similarly to that of a hitch ball attachment found on a trailer hitch, including having similar dimensions, such as a similar diameter, and may be shaped to complement a concave surface of a coupler. In an embodiment, the coupling head 120 is secured to an upper or first end of an inner or first sleeve 158 of the height adjustable assembly 114. The coupling head 120 includes a post 152 or other securement means for securement of the coupling head 120 to the inner sleeve 158. In an embodiment, the coupling head 120 may be formed integrally with the inner sleeve 158.

The height adjustable assembly 114 is a telescoping assembly that extends or lengthens and retracts or shortens to alter a height of the tongue weight scale 100 and includes the inner sleeve 158 and an outer or second sleeve 166. In the embodiment shown in FIGS. 1-4, the inner sleeve 158 is a telescoping tube that is slidably adjustable relative to the outer sleeve 166. The outer sleeve 166 of the telescoping, height adjustable assembly 114 is coupled to a load cell housing 174 within which the load cell 146 is secured, and the load cell housing 174 is secured to the foot 122.

The inner sleeve 158 includes at least one pair of pin receiving apertures 182 extending therethrough for receiving a pin for securing the inner sleeve 158 to the outer sleeve 166 at a selected weight measurement height that corresponds to a height of the hitch ball secured to the tow vehicle. In an embodiment shown in FIG. 2, a plurality of pairs of apertures 182 extend in vertically spaced alignment on the inner sleeve 158 to accommodate a range of weight measurement heights for different hitch ball and tow vehicle configurations. In FIG. 3, the apertures shown in the cross-sectional view are each positioned directly across from a complementary aperture to form each pair or set of apertures 182.

As best seen in FIGS. 1 and 3, at least one pair of second apertures 190 (see FIG. 3) is formed in the outer sleeve 166 proximate an upper end thereof or proximate an end from which the inner sleeve 158 is extendable. The inner sleeve 158 is telescopingly mounted within the outer sleeve 166 and adjustably slidable relative to the outer sleeve 166 to a selected height of the coupling head 120 relative to the foot 122 or a weight measurement height, and until at least one of the pairs of pin receiving apertures 182 extending through the inner sleeve 158 is aligned with the at least one pair of second apertures 190 on the outer sleeve 166. At least one securing pin 204 is then inserted through at least one pair of apertures 182 of the inner sleeve 158 aligned with the at least one pair of second apertures 190 of the outer sleeve 166 to selectively secure the inner sleeve 158 at a longitudinal position relative to the outer sleeve 166 at the weight measurement height of the coupling head 120. It is foreseeable that two or more of the coupling head 120, the inner sleeve 158, and the outer sleeve 166 may be secured to each other or integrally formed together.

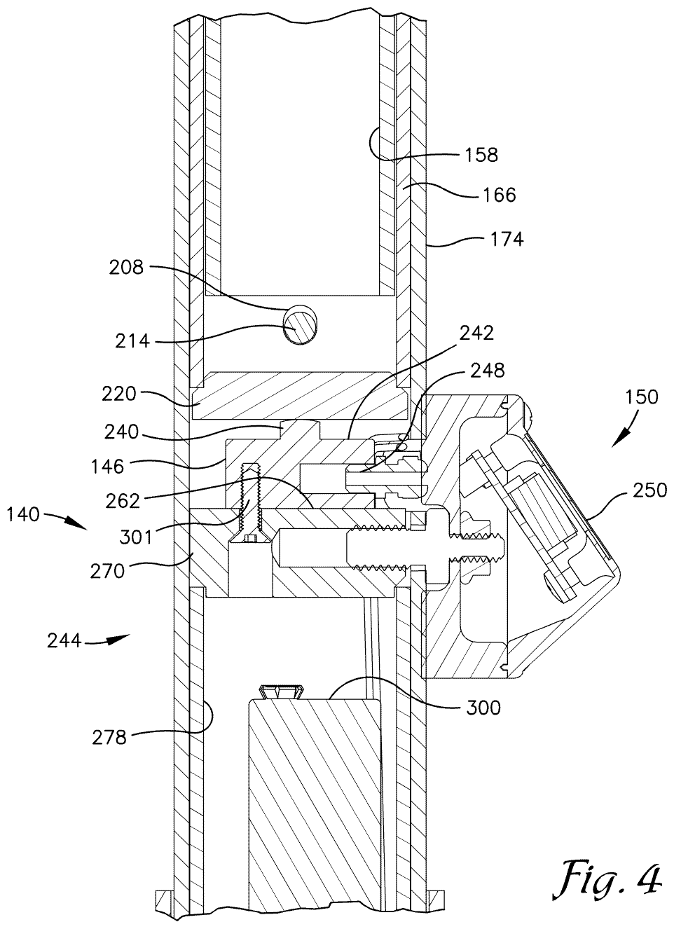

The load cell housing 174 is secured to the inner sleeve 158 and/or the outer sleeve 166 and houses and supports the weight measuring assembly 140, except for the display assembly 150, which may be mounted on an exterior of the load cell housing 174. As shown in FIGS. 3 and 4, the outer sleeve 166 of the height adjustable assembly 114 is coupled or pinned to the load cell housing 174 by a connecting pin 214 extending through aligned pairs of apertures 208 extending through a lower end of the outer sleeve 166 and apertures 212 extending through the load cell housing 174, which may be positioned approximately medially along the length of the load cell housing 174 and/or at least above the load cell 146. A diameter of the apertures 212 in the load cell housing 174 is approximately equal to or slightly greater than a diameter of the connecting pin 214 to secure the connecting pin 214 therein. The aligned apertures 208 in the outer sleeve 166 are generally oblong. A longitudinal axis of the oblong aperture 208 extends parallel to a longitudinal axis of the tongue weight scale 100 or parallel to an axis associated with the downward force of the coupler on the coupling head 120. The longitudinal axis of the oblong aperture 208 is greater than a diameter of the pin 214 and/or a range of motion of the outer sleeve 166, such that the outer sleeve 166 is able to move longitudinally relative to the load cell housing 174 when a force is exerted on the coupling head 120 to exert the force on the weight measuring assembly 140 for sensing and providing a measurement of the force upon the coupling head 120 of the tongue weight scale 100. Longitudinal movement of the outer sleeve 166 is limited by engagement of upper or lower edges of the oblong aperture 208 by the pin 214 extending through the oblong apertures 208 in the outer sleeve 166 and the apertures 212 in the load cell housing 174.

A distal end of the outer sleeve 166, opposite the coupling head 120, is positioned in engagement with the weight measuring assembly 140 that includes the load cell 146 secured within the load cell housing 174, a bearing member or plate 220 engaging a load supporting feature or load button 240 and/or an upper leg or upper surface or portion 242 of the load cell 146, a weight measuring assembly base 244 that supports the load cell 146, and the display assembly 150. In an embodiment, the coupling head 120 and the inner sleeve 158, which is secured to the outer sleeve 166, are connected to the load cell 146, such that a load or force exerted on the coupling head 120 is transmitted through the outer sleeve 166 to the bearing plate 220 of the weight measuring assembly 140. The force exerted on the bearing plate 220 is evenly transmitted around the perimeter or proximate the circumference of the bearing plate 220 where the outer sleeve 166 engages the bearing plate 220. The bearing plate 220 transmits the exerted force to the load button 240 of the load cell 146. The load cell 146 is positioned such that the load button 240 is centered under the bearing plate 220 such that the force of the bearing plate 220 is applied vertically to the load button 240 of the load cell 146. The load button 240 is formed with a convex top or load point to ensure accurate measurement of the applied force. The load cell 146 transforms the force into an electrical output that is communicatively transmitted to the display assembly 150 via a cable (not shown) extending through a cable conduit 248 (see FIG. 4) that extends through an opening between the load cell 146 and the display assembly 150. The display assembly 150 shown in FIGS. 2 and 4 is positioned near or adjacent to the load cell 146 and converts the electrical signal of the load cell 146 to a visual or numeric value associated with the force of the tongue weight of the coupler of the trailer. In the embodiment shown, the display assembly 150 includes a load cell indicator or display 250 for displaying the numeric value associated with the force on the coupler, and the display 250 is coupled on an exterior of the load cell housing 174 of the tongue weight scale 100. It is contemplated that the display assembly 150 may support wired and wireless connections to a variety of devices for displaying or using the measured tongue weight of the coupler of the trailer.

In the embodiment shown, deflection or deformation of a sensing element, such as a strain gauge, of the load cell 146 by the exerted or applied force is converted into an electrical signal that is captured or transmitted to a load cell conditioner or processor communicatively connected to the load cell 146. Signal conditioning functions may include, for example, one or more of excitation voltage, filtering, amplification, and signal conversion. Signal processing functions may include calibration, such that the force applied to the tongue weight scale 100 is proportional to the electrical output signal. The display assembly 150 may include a load cell processor, or a load cell processor may be a separate component in the tongue weight scale 100. After modification of the electrical signal, the conditioned and/or processed electrical signal is transmitted to the display assembly 150.

A lower leg or lower surface or portion 262 of the load cell 146 is secured to the weight measuring assembly base 244 that is secured to or supported above the foot 122. The weight measuring assembly base 244 includes a mount 270 that rigidly extends within the load cell housing 174. In an embodiment shown in FIGS. 2-4, the weight measuring assembly base 244 includes an inner support structure 278, and the mount 270 is supported on an upper end of the inner support structure 278, which in the embodiment shown comprises a tube. The inner support structure 278 extends from the mount 270 to the foot 122 and is secured to and seated in a bracket or collar or hub 280 projecting upward from the foot 122.

In the embodiment shown in FIGS. 1-4 and as best seen in FIG. 2, the inner support structure 278 of the weight measuring assembly base 244 and the load cell housing 174 house a power supply 300 that provides power to the display assembly 150. It is foreseeable that the power supply 300 could be alternatively positioned within the tongue weight scale 100 or on an exterior of the tongue weight scale 100. The power supply 300 shown is a 9-volt battery. Power may be provided from one or more of a variety of power supplies 300, including the 9-volt battery and other types of batteries that may be housed within the tongue weight scale 100, and power sources that are not housed within the tongue weight scale 100, such as, for example, a 9-volt battery, a conventional electrical outlet, a 12V battery, a generator, a solar panel, other types of energy storage devices, such as a fuel cell, and other power sources known by one skilled in the art.

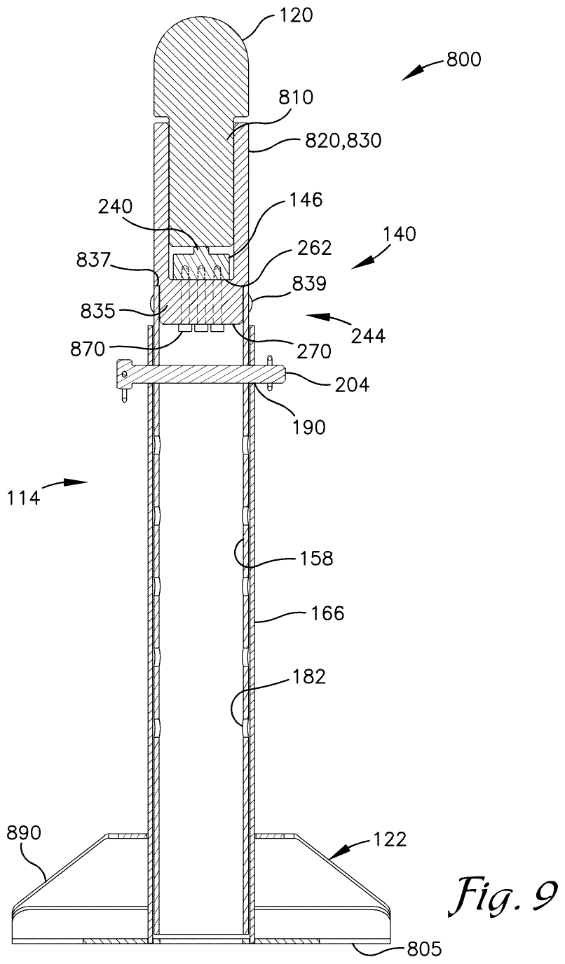

One or more threaded fasteners 301 are used to secure the load cell 146 to the mount 270. In an embodiment, the load cell 146 is securely supported on the mount 270 and an even contact surface between the load cell 146 and the mount 270 is achieved. A top surface of the mount 270, on which the load cell 146 is secured, is positioned to be parallel to a bottom surface of the bearing plate 220. In this embodiment, the mount 270, the inner support structure 278, and the foot 122 are formed to provide a rigid support structure for the load cell 146 and to support the force of the tongue weight on the tongue weight scale 100 with little to no vertical deflection of the position of the load cell 146. In an embodiment, the mount 270 also supports the display assembly 150. A fastener extends from the mount 270 and through the load cell housing 174 to secure the display assembly 150 to the exterior of the load cell housing 174 of the tongue weight scale 100. As shown in FIGS. 5 and 9, the load cell 146 may be supported above and on the mount 270.

In an embodiment shown in FIG. 3, the load cell housing 174 is coupled to a lower end of the outer sleeve 166, and a distal end of the load cell housing 174 is secured and seated within the collar 280 formed on the foot 122. The load cell housing 174 encloses at least the load cell 146 and the weight measuring assembly base 244, which includes the mount 270 and the inner support structure 278. In an embodiment, the inner support structure 278 extends within the load cell housing 174, and inner support structure 278 and the load cell housing 174 are secured to the foot 122 by a pin 302 extending through sets or pairs of aligned apertures in each of the collar 280 of the foot 122, the load cell housing 174, and the inner support structure 278 to maintain the tongue weight scale 100 in an upright position and within the collar 280 of the foot 122. At least the pair of apertures in the collar 280 of the foot 122 rigidly secures the load cell housing 174 and the inner support structure 278 therein.

In the embodiments shown, the foot 122 includes a flat base 320 for supporting the tongue weight scale 100 on a surface. Alternatively, a jack stand (not shown) may support the tongue weight scale 100 and/or the foot 122 supporting the tongue weight scale 100. The jack stand may be any one of a variety of jack stands known to one skilled in the art, including, for example, lever, ratchet, screw, and hydraulic varieties, and three-legged, four-legged, and reinforced base varieties.

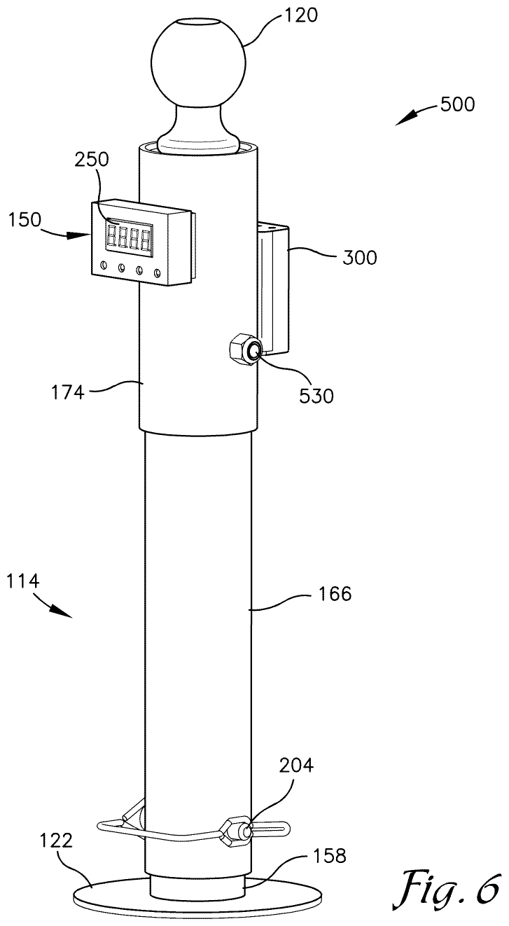

A cross-sectional view of an alternate embodiment 500 of the tongue weight scale is shown in FIG. 5 and includes similar components to those shown in the tongue weight scale 100. The similar components of the tongue weight scale 500 may be identified with the same reference numbers and/or reference names as those used in the description of the tongue weight scale 100. The tongue weight scale 500 includes a height adjustable assembly 114 coupled to a ball mount or coupling head 120 for supporting a coupler of a trailer thereon, and a foot 122 mounted on a lower end of the height adjustable assembly 114 for supporting the tongue weight scale 500 on a surface. A weight measuring assembly 140 contained in the tongue weight scale 500 is secured above the height adjustable assembly 114 and includes a load cell 146 and a weight measuring assembly base 244 that includes a mount 270 for rigidly securing the load cell 146 within the tongue weight scale 500. The weight measuring assembly 140 also includes display assembly 150 (see FIG. 6) that is configured to receive a signal from the load cell 146 and to display a tongue weight of a coupler of a trailer acting on the tongue weight scale 500. The display assembly 150 communicatively transmits tongue weight information to a display 250 and/or another device.

The load cell 146 shown in this embodiment of the tongue weight scale 500 is an S-shaped load cell that measures the compressive force of the tongue on the coupling head 120, but it is understood by one skilled in the art that other types of load cells configured for compressive loads can be utilized in this embodiment. The load cell 146 includes an upper leg 242 and a lower leg 262. The load cell 146 generally comprises one or more strain gauges which detect a force applied to the coupling head 120 through changes in electrical resistance. In an embodiment, the load cell 146 includes more than one strain gauge to increase the measurement accuracy. The load cell 146 provides an output signal that is associated with the changes in electrical resistance.

The height adjustable assembly 114 of the tongue weight scale 500 is shown in FIGS. 5 and 6 and includes an inner or first sleeve 158 and an outer or second sleeve 166. In this embodiment, the inner sleeve 158 is secured to the foot 122 and telescopingly mounted within the outer sleeve 166 and includes at least one first set or pair of apertures 182 for selectively securing a longitudinal position of the inner sleeve 158 relative to the outer sleeve 166 to adjust a height of the coupling head 120 relative to the foot 122. In an embodiment, a plurality of pairs of apertures 182 extends in vertically spaced alignment through the inner sleeve 158, and the outer sleeve 166 is slidably adjustable on the inner sleeve 158 and includes at least one set or pair of second mounting apertures 190 selectively alignable with at least one of the pairs of apertures 182 in the inner sleeve 158 and securable thereto in the selected vertical alignment by a securing pin 204, such that the height of the tongue weight scale 500 is adjustable.

An outer or upper housing 174 is secured to an upper end of the outer sleeve 166 and supports the coupling head 120 and contains the load cell 146. The upper housing 174 may also be referred to as a load cell housing 174. A bolt 530 extends through aligned sets of apertures 540 in the load cell housing 174 and in the outer sleeve 166, fixing the load cell housing 174 to the outer sleeve 166. The apertures 540 in the load cell housing 174 have a generally oblong shape, functioning similar to apertures 208 in the tongue weight scale 100 as described herein and allowing the load cell housing 174 a range of motion when a forced is exerted on the coupling head 120. It is foreseeable that the load cell housing 174 may be formed integrally with the outer sleeve 166.

The weight measuring assembly base 244 supports the load cell 146 and includes the bolt 530 and the mount 270. The bolt 530 extends through and rigidly supports the mount 270 that is positioned within one or both of the outer sleeve 166 and the load cell housing 174 of the tongue weight scale 500. The mount 270 is configured to provide a rigid support structure for the load cell 146 and to support the force of the tongue weight on the tongue weight scale 500 with little to no vertical deflection of the position of the load cell 146 positioned thereabove. The mount 270 includes at least one threaded post or mount 550 extending upward therefrom. The at least one threaded post 550 extends parallel to a longitudinal axis of the tongue weight scale 500 or parallel to an axis associated with the downward force of the coupler on the coupling head 120 and is threadingly connected to a lower leg 262 the load cell 146. In an embodiment, the threaded post 550 secures and positions the load cell 146 in spaced relation above the mount 270. The mount 270 provides a support structure that rigidly secures the load cell 146 within at least the load cell housing 174.

The coupling head 120 includes a post 560 that extends through a mount or support plate 570 that is secured across an upper end of the load cell housing 174. The post 560 is threadingly connected to the upper leg 242 of the load cell 146. As shown in FIG. 5, the load cell 146 is secured between the coupling head 120 and the mount 270, and the coupling head 120 transfers a force applied thereon directly to the load cell 146.

The display assembly 150 is configured to receive the output signal from the load cell 146. In an embodiment, the display assembly 150 is communicatively connected to a display 250 secured to the load cell housing 174 on the tongue weight scale 500. The display assembly 150 may be configured to support other wired or wireless connections to other displays or devices.

In the embodiment as shown in FIG. 6, a power supply 300 is supported on an exterior of the housing and is connected to the display assembly 150. Power may be provided from one or more of a variety of power supplies 300 as previously described herein, such as, for example, a 9-volt battery or another type of battery, a conventional electrical outlet, or a 12V battery. Other power sources known by one skilled in the art may also be used to power the display assembly 150, including, for example, another type of energy storage device, such as a fuel cell, a generator, or a solar panel.

In the embodiments shown, the foot 122 includes a base 320 for supporting the tongue weight scale 100 on a surface. The inner sleeve 158 of the height adjustable assembly 114 may be formed integral with the foot 122 or secured to the foot 122. Alternatively, a jack stand (not shown) may support the tongue weight scale 500 and/or the foot 122 on which the tongue weight scale 500 is supported. The jack stand may be any one of a variety of jack stands known to one skilled in the art, including, for example, lever, ratchet, screw, and hydraulic varieties, and three-legged, four-legged, and reinforced base varieties

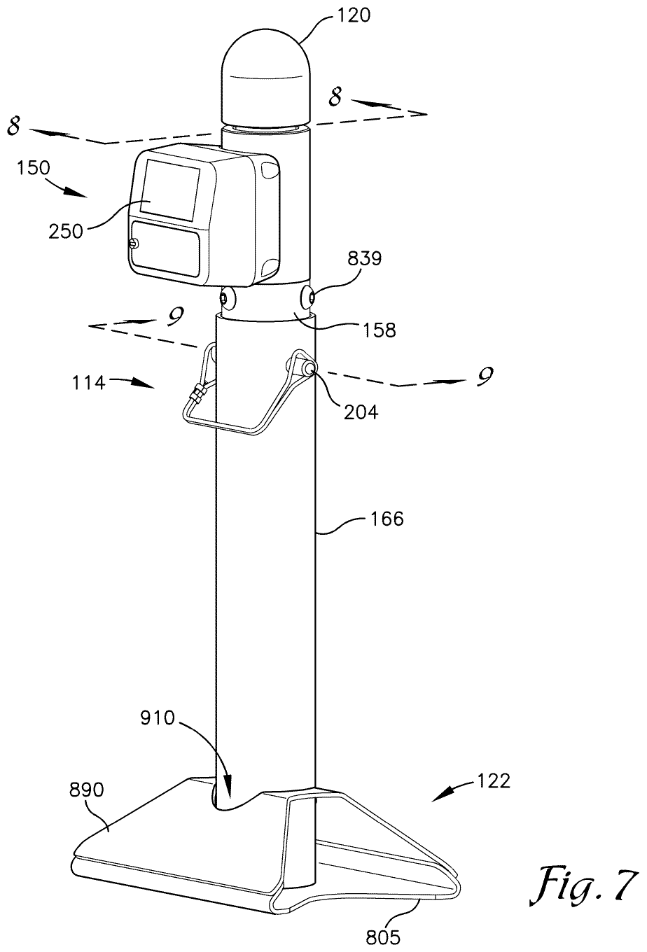

Another embodiment of a tongue weight scale 800 is shown in FIGS. 7-9. This embodiment includes similar components to those shown in the tongue weight scale 100, and the reference numbers and/or reference names associated with those similar components in the tongue weight scale 100 may be used to describe the tongue weight scale 800. The tongue weight scale 800 includes a height adjustable assembly 114 coupled to a ball mount or coupling head 120 for supporting a coupler thereon, and a foot 122 having a base 805 and mounted on a lower end of the height adjustable assembly 114 for supporting the tongue weight scale 800 on a surface. A weight measuring assembly 140 contained in the tongue weight scale 800 is secured above the height adjustable assembly 114 and includes a load cell 146 and a weight measuring assembly base 244 that includes a mount 270 for rigidly securing the load cell 146 within the tongue weight scale 800. The weight measuring assembly 140 also includes a display assembly 150 that is configured to receive a signal from the load cell 146 and to display a tongue weight of a coupler of a trailer acting on the tongue weight scale 800. The display assembly 150 communicatively transmits tongue weight information to a display 250 and/or another device.

The load cell 146 shown in this embodiment of the tongue weight scale 800 is a button load cell 146, which is similar to the load cell 146 described with reference to tongue weight scale 100 and includes a load button 240. It is understood by one skilled in the art that other types of load cells configured for compressive loads can be utilized in an embodiment of the tongue weight scale 800.

The coupling head 120 shown is dome-shaped and sized to support the tongue or coupler thereon. The coupling head 120 transmits a force exerted thereon to a load cell 146. A post 810 having a dimension or diameter just smaller than an inside diameter of an upper housing or load cell housing 820, is coupled to or formed integral with the coupling head 120 and extends into the upper housing 820 and is supported in a vertical or longitudinal orientation by an inner surface of a sidewall 830 of the upper housing 820. The post 810 is slidable along a longitudinal axis of the tongue weight scale 800 or is able to move longitudinally relative to the upper housing 820 to engage the weight measuring assembly 140 when a force is applied to the coupling head 120. The post 810 functions as a bearing plate of the coupling head 120 and has a flat bottom surface that engages a top of the load button 240 of the load cell 146. The load button 240 is centrally positioned under the post 810, and when a load or force is applied to the coupling head 120, the post 810 moves vertically to transmit the load to the load cell 146. As discussed herein, an electrical output from the load cell 146 is communicatively transmitted to the display assembly 150 that is communicatively connected to a display 250 to display a tongue weight of a coupler acting on the coupling head 120.

The height adjustable assembly 114 of the tongue weight scale 800 includes an inner sleeve 158 and an outer sleeve 166. The height adjustable assembly 114 supports the weight measuring assembly 140 thereabove. In an embodiment, the outer sleeve 166 is secured to or formed integrally with the foot 122, and the inner sleeve 158 is telescopically mounted within the outer sleeve 166 and slidably adjustable relative to the outer sleeve 166 to a selected height and until at least one set or pair of pin receiving apertures 182 extending through the inner sleeve 158 is selectively aligned with at least one set or pair of second apertures 190 in the outer sleeve 166 for selectively securing a longitudinal position of the inner sleeve 158 relative to the outer sleeve 166 to adjust a height of the coupling head 120 relative to the foot 122. At least one securing pin 204 is then inserted through the aligned at least one set of apertures 182 of the inner sleeve 158 and the at least one set of second apertures 190 of the outer sleeve 166 to secure the inner sleeve 158 to the outer sleeve 166 at the selected vertical alignment that corresponds to the weight measurement height.

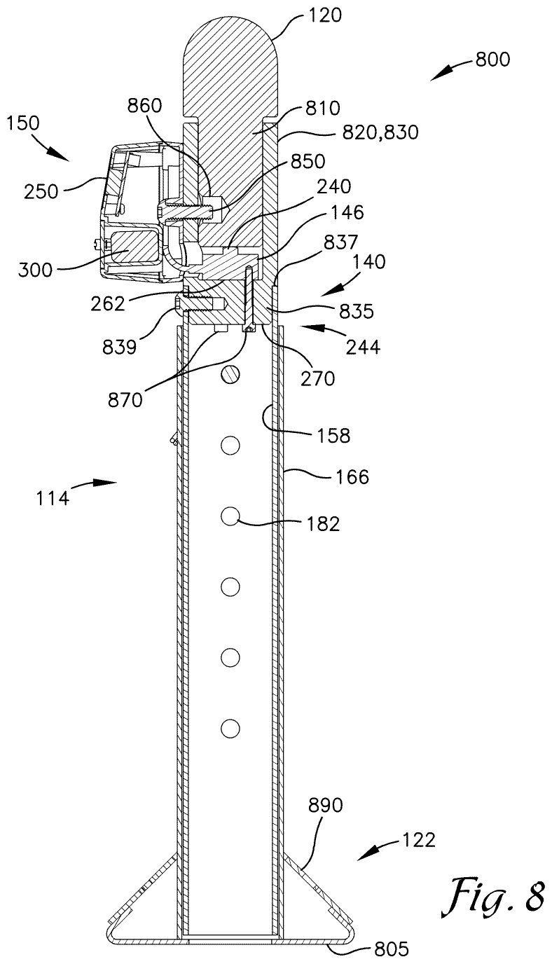

In an embodiment, the upper housing 820 is secured to or formed integrally with an upper end of the inner sleeve 158, and the upper housing 820 supports at least the coupling head 120 slidably contained therein and the load cell 146 rigidly supported therein. In an embodiment shown in FIGS. 8 and 9, the upper housing 820 includes a connection insert or fitting 835 inserted within a top of the inner sleeve 158, and the top of the inner sleeve 158 engages a flange 837 extending between the fitting 835 and the sidewall 830 of the upper housing 820 to position the inner sleeve 158 relative to the upper housing 820. The fitting 835 is secured to the inner sleeve 158 by at least one fastener 839 extending through the fitting 835 and the inner sleeve 158.

An embodiment shown in FIG. 7 also includes the display assembly 150 mounted on the upper housing 820. As shown in FIG. 8, the display assembly 150 includes at least one bolt 850 that secures the display assembly 150 to the upper housing 820. The post 810 of the coupling head 120 is formed with a cavity or aperture 860 such that movement of the coupling head 120 relative to the upper housing 820 does not engage the at least one bolt 850 of the display assembly 150. Specifically, the cavity 860 is formed having a dimension greater than a diameter of the bolt 840 and greater than a range of motion of the post 810 along an axis parallel to the axis of movement of the post 810.

The weight measuring assembly base 244 of the upper housing 820 includes a mount or a support base 270 positioned below the load cell 146 and formed across or secured on a lower end of the upper housing 820. The mount 270 supports and secures the load cell 146 within the upper housing 820 between the mount 270 and the post 810 of the coupling head 120. In an embodiment, at least one threaded fastener 870 extends through the mount 270 and into a lower surface 262 the load cell 146 to secure the load cell 146 to an upper surface of the mount 270. The mount 270 is configured to provide a support structure to rigidly secure the load cell 146 within the upper housing 820, and the at least one threaded fastener 870 secures the load cell 146 to the mount 270 such that the load cell 146 of the weight measuring assembly 140 is engageable with the post 810 of the coupling head 120 to measure a tongue weight associated with a coupler in engagement with the coupling head 120.

In an embodiment shown in FIG. 8, the display assembly 150 includes a power supply 300 that is a 9-volt battery that provides power to at least the display assembly 150. It is foreseeably that other power sources known in the art could be used to provide power to the tongue weight scale 800 and that the power source 300 could be alternatively positioned on or within the tongue weight scale 800 or separate from the tongue weight scale 800.

In an embodiment, the foot or support 122 of the tongue weight scale 800 includes the base 805 and a bracket 890 with a central opening 910 extending therethrough through which the tongue weight scale 800 extends and is supported in an upright position. The outer sleeve 166 of the tongue weight scale 800 may be secured to or formed integrally with the base 805. The bracket 890 is secured to the base 805 and is angled upward from the base 805 to form a truncated pyramidal-shaped support for the tongue weight scale 800 with the opening 910 through an upper or top base of the bracket 890. It is foreseeable that other supports known to one skilled in the art could be used to support the tongue weight scale 800.

It is foreseen that the components described herein could be formed from a variety of materials and using a variety of methods. Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

It is to be understood that while certain forms of the present invention have been illustrated and described herein, it is not to be limited to the specific forms or arrangement of parts described and shown. As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed is:

1. A weighing device comprising:
a coupling head configured to support a coupler of a trailer thereon;
a height adjustable assembly adjustable to position the coupling head at a weight measurement height;
a foot configured to support the weighing device on a surface;
a weight measuring assembly that detects and transmits an output signal that corresponds to a force exerted on the coupling head, the weight measuring assembly including a mount spaced above the foot that is positioned to support a weight measurement device in a position to be engaged when the force is exerted on the coupling head; and
a housing secured to the height adjustable assembly and configured to support the weight measuring assembly.

2. The weighing device of claim 1, wherein the coupling head includes a post that is moveably supported by a sidewall of the housing and configured to engage the weight measurement device when the force is exerted on the coupling head.

3. The weighing device of claim 1, wherein the coupling head is moveable within a range of motion limited by at least one aperture to engage the weight measuring assembly when the force is exerted on the coupling head.

4. The weighing device of claim 1, wherein the height adjustable assembly includes a plurality of pairs of apertures vertically aligned on a first sleeve adjustably securable to at least one pair of aligned pin receiving apertures extending through a second sleeve.

5. The weighing device of claim 1, wherein the weight measurement device is a load cell that includes one or more strain gauges.

6. The weighing device of claim 1, wherein the housing is secured above the height adjustable assembly by a fitting and the mount is formed across a lower end of the housing having at least one fastener that secures the weight measurement device thereabove.

7. The weighing device of claim 1, further comprising a display assembly coupled to the housing adjacent to the weight measurement device.

8. A weighing device comprising:
a coupling head configured to support a coupler of a trailer thereon;
a foot configured to support the weighing device on a surface;
a height adjustable assembly comprising a first sleeve telescopingly mounted within a second sleeve and a means for selectively securing a longitudinal position of the first sleeve relative to the second sleeve to adjust a height of the coupling head relative to the foot; and
a load cell supported within a load cell housing that is coupled to the height adjustable assembly, the load cell secured above a mount within the load cell housing, and the load cell including one or more sensing elements that are configured to detect a force applied to the coupling head and transmit an output signal that corresponds to the force; wherein the force applied to the coupling head causes the coupling head to move within a range of motion limited by at least one aperture to engage the load cell.

9. The weighing device of claim 8, wherein the coupling head includes a post coupled to or formed integrally therewith and that extends within the load cell housing, and the post transmits the force applied to the coupling head to the load cell.

10. The weighing device of claim 8, wherein the means for selectively securing the longitudinal position of the first sleeve relative to the second sleeve includes a plurality of pairs of apertures vertically aligned on the first sleeve adjustably securable to at least one pair of aligned pin receiving second apertures extending through the second sleeve.

11. The weighing device of claim 8, wherein the load cell housing includes a fitting that is secured within the first sleeve of the height adjustable assembly, and the mount is formed across a lower end of the load cell housing to rigidly secure the load cell therein.

12. The weighing device of claim 8, wherein the mount includes a fastener that is in threading engagement with the load cell and secures the load cell relative to the mount.

13. The weighing device of claim 8, further comprising a display assembly, wherein the load cell is communicatively connected to the display assembly that includes a display coupled on an exterior of the weighing device.

14. A weighing device comprising:
a coupling head configured to support a coupler of a trailer thereon, the coupling head including a post extending therefrom;
a height adjustable assembly comprising a first sleeve that telescopically moves relative to a second sleeve and a means for securing the first sleeve to the second sleeve;
a load cell housing secured to the first sleeve of the height adjustable assembly at an upper end thereof, the post of the coupling head extending within the load cell housing, and the post moveably supported by sidewalls of the load cell housing;
a load cell mounted within the load cell housing, the coupling head moveable such that the post engages the load cell when a force is exerted on the coupling head, and the load cell configured to detect a force applied to the coupling head to provide an output signal; and
a display assembly configured to receive the output signal and display a numeric value corresponding to the output signal.

15. The weighing device of claim 14, wherein the coupling head is moveable within a range of motion limited by at least one aperture to engage the load cell when the force is exerted on the coupling head.

16. The weighing device of claim 14, wherein the means for securing the first sleeve to the second sleeve includes a plurality of pairs of apertures vertically aligned on the first sleeve adjustably securable to at least one pair of aligned pin receiving apertures extending through the second sleeve to selectively secure the height adjustable assembly at a weight measurement height.

17. The weighing device of claim 14, wherein the load cell housing includes a fitting that is secured within the first sleeve of the height adjustable assembly, and a mount is formed across a lower end of the load cell housing.

18. The weighing device of claim 14, wherein the display assembly includes at least one bolt that secures the display assembly to the load cell housing, and the post is formed with an aperture having a dimension along an axis parallel to an axis of movement of the post such that movement of the coupling head relative to the load cell housing does not engage the at least one bolt of the display assembly.

19. The weighing device of claim 14, further comprising a mount secured within the load cell housing and at least one fastener extending therefrom, the mount configured to rigidly secure the load cell in a position to be engaged by the post of the coupling head.
